(19) United States
(12) Patent Application Publication
(10) Pub. No.: US 2017/0024604 A1
(43) Pub. Date: Jan. 26, 2017

(54) IMAGING APPARATUS AND METHOD OF OPERATING THE SAME

(71) Applicant: SAMSUNG ELECTRONICS CO., LTD., Suwon-si (KR)

(72) Inventors: Sung-hyun CHO, Suwon-si (KR); Jeong-won LEE, Seongnam-si (KR)

(21) Appl. No.: 14/971,205

(22) Filed: Dec. 16, 2015

(30) Foreign Application Priority Data
Jul. 22, 2015 (KR) 10-2015-0103878

(51) Int. Cl. G06K 9/00; G06T 7/00; H04N 5/232; G06F 3/01; H04N 5/225

(52) U.S. Cl. CPC G06K 9/0061; G06K 9/00604; G06F 3/013; H04N 5/2256; H04N 5/23219; G06T 7/0018; G06T 2207/30201

(57) ABSTRACT

An imaging apparatus includes image capturing circuitry configured to capture an image including a reference pupil showing an entire shape of a pupil of an eye of a user and an image including a partial pupil showing a portion of the pupil, and a controller configured to determine a difference value between a first center that is determined based on the entire shape of the reference pupil and a second center that is determined based on a partial shape of the reference pupil, to determine an error correction value for correcting an error related to a center of the partial pupil based on the difference value, and to determine the center of the partial pupil by using the error correction value.

### CROSS-REFERENCE TO RELATED APPLICATION

This application is based on and claims priority under 35 U.S.C. §119 to Korean Patent Application No. 10-2015-0103878, filed on Jul. 22, 2015, in the Korean Intellectual Property Office, the disclosure of which is incorporated by reference herein in its entirety.

### BACKGROUND

1. Field

The disclosure relates to an imaging apparatus and a method of operating the same, and for example, to an imaging apparatus that tracks a user's eye gaze, and a method of operating the imaging apparatus.

2. Description of Related Art

An imaging apparatus may include, for example, a button, a keyboard, a touchpad, a touch screen, a gyro sensor, and/or a gesture sensor to receive control signals of a user. In addition, the imaging apparatus may use an infrared sensor to track a user's eye gaze and receive control signals corresponding to tracked gaze positions.

Recently, the user's eye gaze is used to receive a user input in an imaging apparatus, for example, a smart television (TV), a smartphone, a tablet personal computer (PC), and a head-mount display (HMD).

In particular, in order to track the user's eye gaze, the imaging apparatus captures an image of an eye of the user, and detects rotation of the eye of the user from the captured image. The user's eye gaze may be tracked by tracking location movements of the pupil of the eye to detect the rotation of the eye.

### SUMMARY

Provided are an imaging apparatus that, when tracking a gaze of a user based on a location of a pupil of an eye of the user, accurately tracks the center of the pupil using a shape of an uncovered portion of the pupil even when a portion of the pupil of the user is covered, and a method of operating the imaging apparatus.

Additional aspects will be set forth in part in the description which follows and, in part, will be apparent from the description.

According to an aspect of an example embodiment, an imaging apparatus includes image capturing circuitry configured to capture an image including a reference pupil showing an entire shape of a pupil of an eye of a user and an image including a partial pupil showing a portion of the pupil, and a controller configured to determine a difference value between a first center based on the entire shape of the reference pupil and a second center based on a partial shape of the reference pupil, to determine an error correction value for correcting an error related to a center of the partial pupil based on the difference value, and to determine the center of the partial pupil using the error correction value.

The controller may be configured to determine whether the partial pupil includes a predefined area, and may be configured to determine the center of the partial pupil when the partial pupil includes the predefined area.

The controller may be configured to determine the error correction value based on the difference value, a size of the reference pupil, and a size of the partial pupil.

The controller may be configured to track a user's eye gaze based on the determined center, and the imaging apparatus may further include a display configured to display at least one object that corresponds to the tracked eye gaze.

When the partial pupil does not include a predefined area, the controller may be configured to display, on the display, the at least one object in a first form indicating that the user's eye gaze is not being tracked.

When the partial pupil includes the predefined area, the controller may be configured to display, on the display, the at least one abject in a second form indicating that the user's eye gaze is being tracked.

The controller may be configured to control the image capturing circuitry to display, on the display, a message for obtaining the image including the reference pupil.

The image capturing circuitry may be configured to capture images of a plurality of reference pupils having a plurality of sizes.

The image capturing circuitry may include an auxiliary light that provides light to the pupil of the user.

The controller may be configured to determine a center of an oval obtained based on the entire shape of the reference pupil as a first center, to determine a center of an oval obtained based on the partial shape of the reference pupil as a second center, and to determine a center of an oval obtained based on a shape of a predefined area of the partial pupil as a center of the partial pupil.

The image capturing circuitry may be configured to obtain the image including the partial pupil when a portion of the pupil of the eye of the user is covered by an eyelid.

The controller may be configured to obtain centers of a plurality of ovals based on the partial shape of the reference pupil, and may be configured to determine a plurality of second centers based on the centers of the plurality of ovals.

According to an aspect of another example embodiment, an imaging method includes obtaining an image including at least one of a reference pupil showing an entire shape of a pupil of an eye of a user and a partial pupil showing a portion of the pupil, determining a difference value between a first center based on the entire shape of the reference pupil and a second center based on a partial shape of the reference pupil, determining an error correction value for correcting an error related to a center of the partial pupil based on the difference value, and determining the center of the partial pupil using the error correction value.

The determining of the error correction value may include determining whether the partial pupil includes a predefined area, and determining the error correction value when the partial pupil includes the predefined area.

The determining of the error correction value may include determining the error correction value based on the difference value, a size of the reference pupil, and a size of the partial pupil.

The imaging method may further include tracking a user's eye gaze based on the determined center, and displaying at least one object that corresponds to the tracked eye gaze on a display.

The imaging method may further include, when the partial pupil does not include a predefined area, displaying, on the display, the at least one object in a first form indicating that the user's eye gaze is not being tracked.

The imaging method may further include, when the partial pupil includes the predefined area, displaying, on the display, the at least one abject in a second form indicating that the user's eye gaze is being tracked.

The imaging method may further include, before obtaining the image including the partial pupil, displaying, on a display, a message for obtaining the image including the reference pupil.

The determining of the error correction value may include determining a center of an oval obtained based on the entire shape of the reference pupil as a first center, determining a center of an oval obtained based on the partial shape of the reference pupil as a second center, and determining a center of an oval obtained based on a shape of a predefined area of the partial pupil as a center of the partial pupil.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIGS. 1A to 1D are diagrams illustrating an example imaging apparatus;

FIGS. 2A and 2B are diagrams illustrating an eye of a user of which an image is captured using an infrared camera;

FIG. 3 is a block diagram illustrating an example imaging apparatus;

FIG. 4 is a block diagram illustrating an example imaging apparatus in greater detail;

FIG. 5 is a flowchart illustrating an example operation method of an imaging apparatus;

FIGS. 6A to 6C are diagrams illustrating an example of determining an error correction value for correcting an error in the center of a partial pupil;

FIGS. 7A to 7D are diagrams illustrating an example imaging apparatus determining the center of a partial pupil using an error correction value;

FIG. 8A is an illustration of an example image provided via a display when an imaging apparatus obtains an image including a reference pupil of a user;

FIG. 8B is an illustration of an example image provided via a display when an imaging apparatus obtains an image including a reference pupil of a user;

FIGS. 9A and 9B are diagrams illustrating an example imaging apparatus determining whether a partial pupil includes a predefined area; and

FIG. 10 is a diagram illustrating an example imaging apparatus displaying, on a display, an indication of whether a gaze of a user is tracked.

### DETAILED DESCRIPTION

Terms used in the disclosure will be briefly described, and example embodiments will be described in greater detail.

The terms used in the example embodiments are selected as general terms used currently as widely as possible, but in specific cases, terms arbitrarily selected may also be used, and in such cases the meanings are mentioned in the corresponding detailed description section, so the disclosure should be understood not by literal meanings of the terms but by given meanings of the terms.

Throughout the disclosure, when a portion “includes” an element, another element may be further included, rather than excluding the existence of the other element, unless otherwise described. In addition, the terms such as “unit,” “-er(-or),” and “module” described in the disclosure may refer to an element for performing at least one function or operation, and may be implemented in hardware (e.g., circuitry), software, or the combination of hardware and software.

Hereinafter, one or more examples embodiments will now be described more fully with reference to the accompanying drawings, and will convey the disclosure to one of ordinary skill in the art. The disclosure may, however, be embodied in many different forms and should not be construed as being limited to the examples set forth herein. Features that are unnecessary for clearly describing the disclosure may not be included in the drawings. Also, throughout the disclosure, like reference numerals in the drawings denote like elements. As used herein, the term “and/or” includes any and all combinations of one or more of the associated listed objects. Expressions such as “at least one of,” when preceding a list of elements, modify the entire list of elements and do not necessarily modify the individual elements of the list.

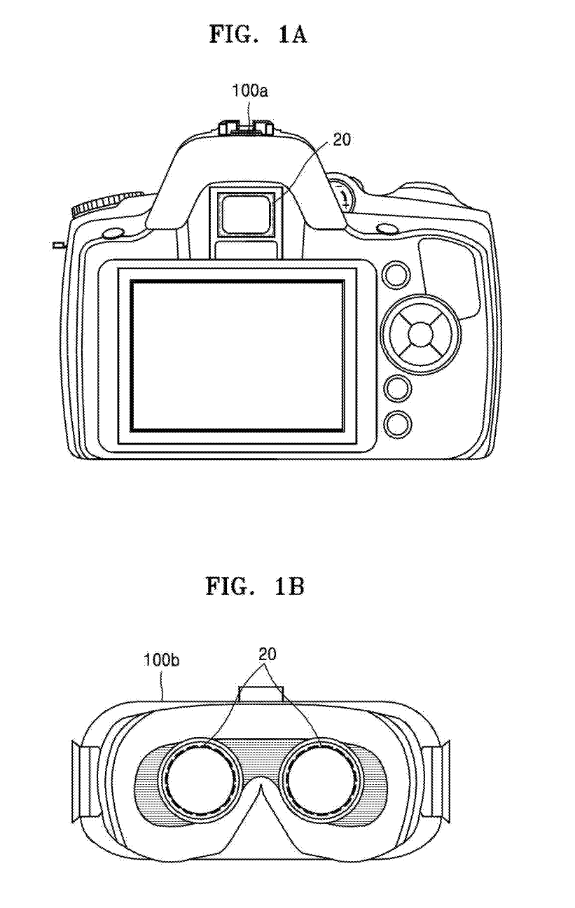

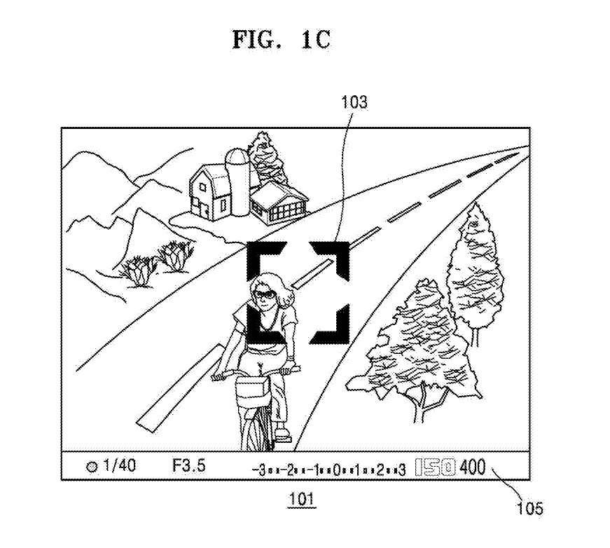

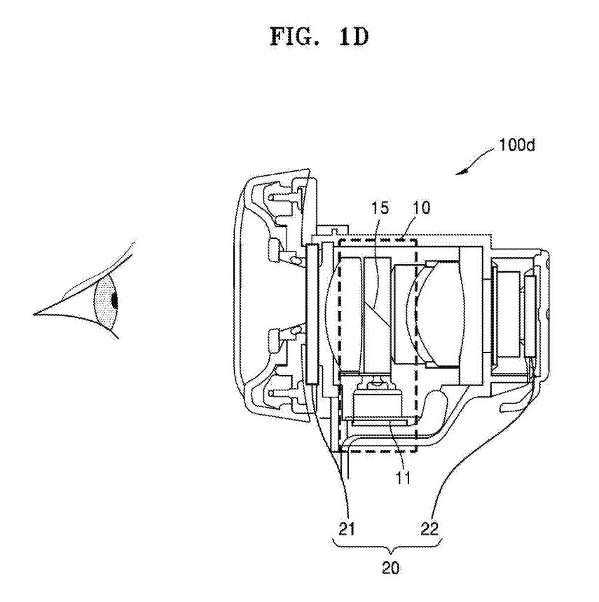

FIGS. 1A and 1B are diagrams illustrating an example imaging apparatus. The example imaging apparatus may be an imaging apparatus 100a of FIG. 1A and an imaging apparatus 100b of FIG. 1B.

Referring to FIG. 1A, the imaging apparatus 100a may, for example, be a photographing apparatus. For example, the photographing apparatus may be, for example, a digital still camera capturing still images or a digital video camera capturing moving images. Also, the photographing apparatus may be a digital single-lens reflex (DSLR) camera, a mirrorless camera, or may be integrated in a smartphone or a tablet PC, or the like. However, the photographing apparatus is not limited thereto and may be any apparatus including a camera module with a lens and an imaging device that is capable of generating images by capturing a subject.

Referring to FIG. 1B, the imaging apparatus 100b may, for example, be a head-mounted display. For example, a head-mounted display may be, for example, a virtual reality (VR) device providing VR images or an augmented reality (AR) device providing AR images, or the like.

The imaging apparatuses 100a and 100b may include, for example, a display 20. The imaging apparatuses 100a and 100b may, for example, provide viewfinder images or VR images via the display 20.

The imaging apparatuses 100a and 100b may include, for example, a camera (not shown) that tracks a gaze of a user. The camera may capture an image of an eye of the user and track the user's eye gaze using the captured image of the eye. The imaging apparatuses 100a and 100b may be configured to detect an area at which the tracked eye gaze remains (area of interest) from the viewfinder images. When an area of interest is detected, the imaging apparatuses 100a and 100b may display the area of interest and perform one or more operations related to the area of interest. For example, the imaging apparatuses 100a and 100b may set focus on the area of interest and capture an image of a subject, etc.

FIG. 1C illustrates an example viewfinder image 101 that may, for example, be provided in the imaging apparatuses 100a and 100b.

The imaging apparatuses 100a and 100b may provide the viewfinder image 101 to the user via the display 20.

The imaging apparatuses 100a and 100b may provide the viewfinder image 101 to the user so that the user may identify a composition including a subject to be captured. Also, on the viewfinder image 101, the imaging apparatuses 100a and 100b may further display information on at least one of a focus location and a photography mode.

Referring to FIG. 1C, the imaging apparatuses 100a and 100b may display an object 103 that corresponds to the tracked eye gaze on the viewfinder image 101.

For example, the imaging apparatuses 100a and 100b may display the object 103 at a location on the viewfinder image 101 corresponding to the user's eye gaze. For example, when the user is looking at a person that has appeared on the viewfinder image 101, the imaging apparatuses 100a and 100b may display the object 103 on the person shown on the viewfinder image 101.

According to an example embodiment, when the imaging apparatuses 100a and 100b receive an input for capturing an image, the imaging apparatuses 100a and 100b may focus on the location displaying the object 103 and capture an image of the subject.

Referring to FIG. 1C, the imaging apparatuses 100a and 100b may further display a user interface 105 that shows photography mode information on the viewfinder image 101. The photography mode may include at least one of shutter speed, aperture settings, exposure settings, and white balance.

FIG. 1D is a diagram illustrating an example imaging apparatus 100d. The imaging apparatus 100d may, for example, be a viewfinder image capturing apparatus.

The viewfinder image capturing apparatus may, for example, be an electronic viewfinder apparatus or an optical viewfinder apparatus. The viewfinder image capturing apparatus may be included in a photographing apparatus or a separable component of the photographing apparatus. For example, the imaging apparatus 100d according to an example embodiment may be included in the imaging apparatus 100a shown in FIG. 1A or a separable component of the imaging apparatus 100a.

Referring to FIG. 1D, the imaging apparatus 100d may include, for example, an image capturing unit 10 and a display 20.

The image capturing unit 10 may include at least one camera 11 and a prism 15.

The at least one camera 11 may, for example, be an infrared ray (IR) camera. The prism 15 may change a path of light such that some of the light incident on a window 21 may be incident on the camera 11. Also, via the window 21, the image capturing unit 10 may capture an image of an eye of the user that is near the window 21. The imaging apparatus 100d may further include at least one lighting unit (now shown) to provide light when the image capturing unit 10 captures the image of the eye of the user. The lighting unit may be provided near the window 21 and may include, for example, infrared ray light-emitting diodes (IR LEDs).

The display 20 may include, for example, the window 21 and a display panel 22. The window 21 may include, for example, a transparent material that transmits light and may be formed as a transparent display. When the window 21 is formed as a transparent display, information related to photography may be displayed on the window 21. Also, the window 21 according to an example embodiment may display, for example, at least one object that corresponds to the user's eye gaze.

The display panel 22 may include, for example, a liquid crystal display (LCD) panel or an organic light-emitting display panel. The display panel 22 may display viewfinder images or VR images.

The imaging apparatuses shown in FIGS. 1A to 1D may track the user's eye gaze by using an image of a pupil of an eye of the user. In an example, the imaging apparatus may determine the center of the pupil based on a shape of the pupil in the obtained image. The imaging apparatus may track the user's eye gaze from the determined center of the pupil. Also, the imaging apparatus may display, on the display unit, an object corresponding to the tracked eye gaze.

According to an example embodiment, when the imaging apparatus obtains an image of a partial pupil of the user, the center of the pupil may be inaccurate. When the user's eye gaze is tracked by using an inaccurately determined center of the pupil, the tracked gaze may have errors.

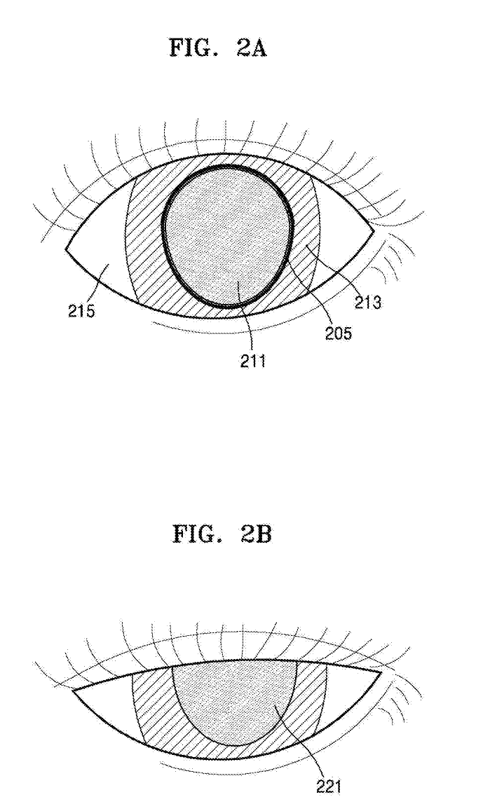

FIGS. 2A and 2B are diagrams illustrating an eye of a user of which an image captured by using an infrared camera.

FIG. 2A is an example image captured when the user has completely opened his/her eye. FIG. 2B is an example image captured when the user has partially opened his/her eye.

The image illustrated in FIG. 2A includes the entirety of a pupil 211. The pupil 211 is located at the center of an iris 213. External light may be transmitted to a retina (not shown) via the pupil 211. The iris 213 is a portion for adjusting a size of the pupil to control an amount of light that enters the pupil. In an image captured by the infrared camera, the pupil 211 may be darker than the iris 213 and a sclera 215.

The pupil 211 of FIG. 2A is oval-shaped. A shape of the pupil 211 may be determined by a shape of the iris 213 that is surrounding the pupil 211. For example, the shape of the pupil 211 surrounding the iris 213 may be an oval of which a width is longer than a height. Alternatively, the pupil 211 may be not an oval that is vertically symmetrical, but a distorted oval. For example, portions of the pupil 211 may have different radii of curvature.

Referring to FIG. 2A, when the pupil 211 is completely shown, the center of the pupil 211 may be found by performing a fitting operation by using an oval 205 that entirely surrounds the pupil 211.

The image illustrated in FIG. 2B includes a partial pupil 221. The partial pupil 221 includes a portion of the pupil 211 shown in FIG. 2A. As described above, the portions of the pupil 211 may each have different radii of curvature. It may be difficult to obtain the center of the pupil when only the partial pupil 221 illustrated in FIG. 2B is used. When the user's eye gaze is tracked by using the center of the pupil that is inaccurately obtained by only using the partial pupil 221, the tracked gaze may include an error. When the center of the pupil is obtained using only the partial pupil 221, the center may be accurately obtained by using an error correction value to reduce the error in the center of the pupil.

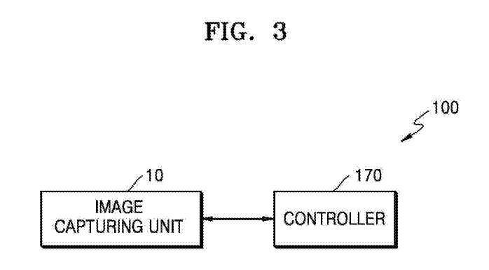

FIG. 3 is a block diagram illustrating an example imaging apparatus 100. The imaging apparatus 100 may, for example, be a photographing apparatus, a head-mounted display, or a viewfinder image capturing apparatus. The imaging apparatus 100 may include the imaging apparatus 100a of FIG. 1A, the imaging apparatus 100b of FIG. 1B, and the imaging apparatus 100d of FIG. 1D.

Referring to FIG. 3, the imaging apparatus 100 may include, for example, an image capturing unit 10 and a controller 170.

The image capturing unit 10 according to an example embodiment may obtain an image including a reference pupil showing an entire shape of the pupil of the user, and/or an image including a partial pupil showing a portion of the pupil.

The reference pupil is the pupil of which an image is captured when the user fully opens his/her eye. For example, as shown in FIG. 2A, the reference pupil may include the pupil 211 of which an image is captured when the user has fully opened his/her eye.

The partial pupil is a portion of the pupil of which an image is captured when the user partially opens his/her eye. For example, as shown in FIG. 2B, the partial pupil may include the partial pupil 221 of which an image is captured when a portion of the pupil is covered by an eyelid.

The controller 170 according to an example embodiment may be configured to determine a difference value between a first center that is determined based on an entire shape of the reference pupil and a second center that is determined based on a partial shape of the reference pupil. For example, the controller 170 may be configured to determine the center of an oval determined based on the entire shape of the reference pupil as the first center, and determine the center of an oval determined based on the partial shape of the reference pupil as the second center.

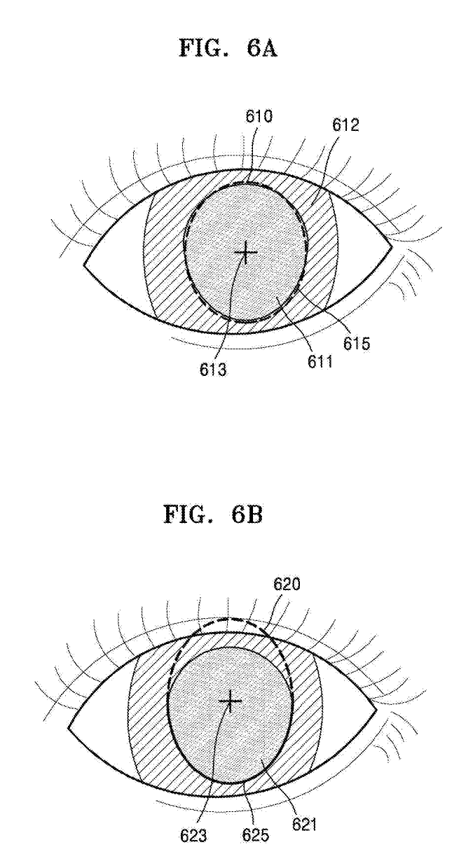

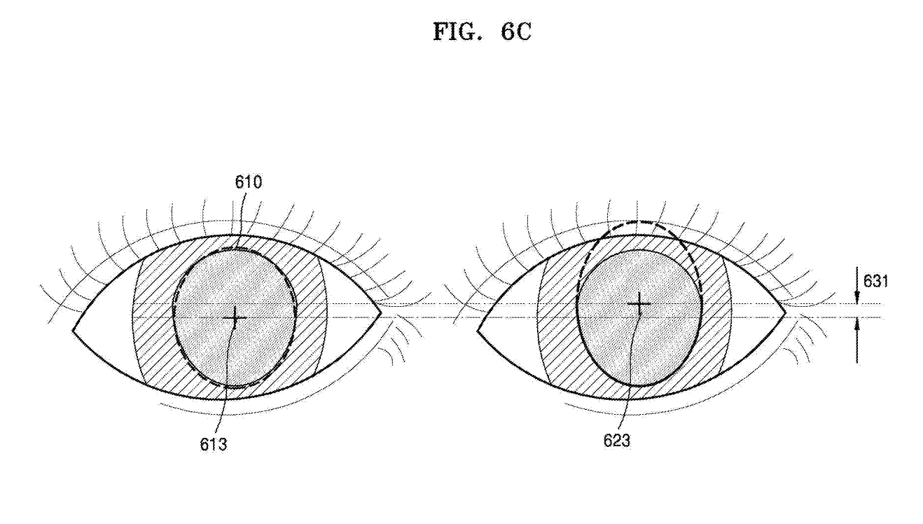

Also, the controller 170 may be configured to determine an error correction value for correcting an error in the center of the partial pupil based on the determined difference value between the first and second centers. The controller 170 may be configured to determine the center of the partial pupil using the determined error correction value. This will be described in greater detail below with reference to FIGS. 6A to 6C.

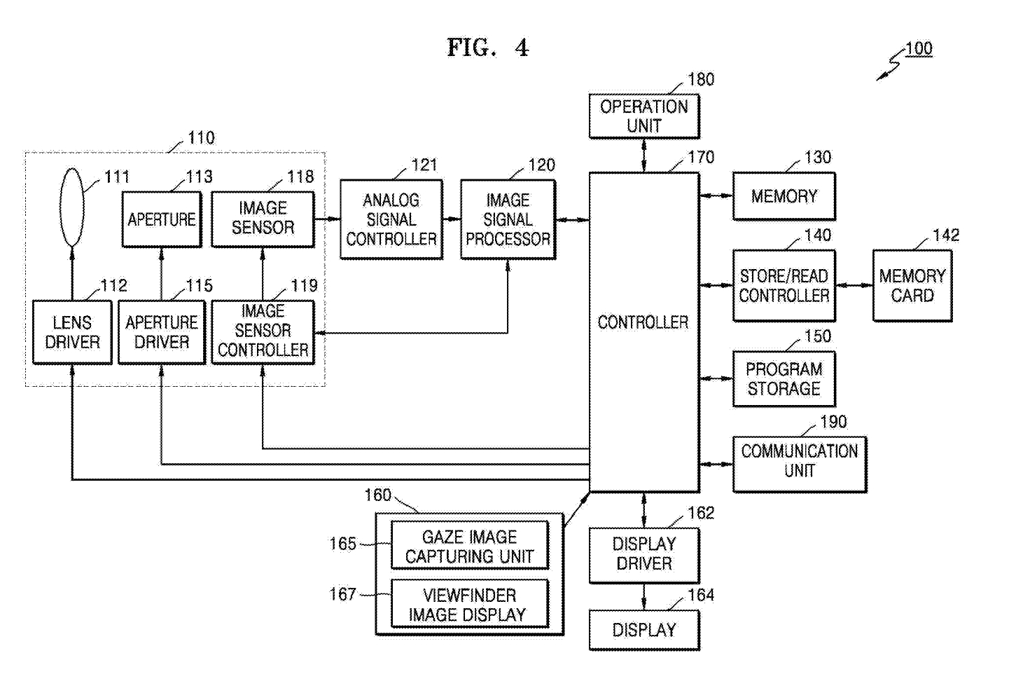

FIG. 4 is a block diagram illustrating an example imaging apparatus 100. The imaging apparatus 100 may, for example, be a photographing apparatus. The photographing apparatus of FIG. 4 may, for example, be the imaging apparatus 100a of FIG. 1A.

The imaging apparatus 100 may include, for example, an image capturing unit 110, an image signal processor 120, an analog signal controller (e.g., processor) 121, a memory 130, a store/read controller (e.g., processor) 140, a memory card 142, a non-transitory program storage unit 150, a display driver 162, a display 164, a viewfinder 160, a controller (e.g., processor) 170, an operation unit 180, and a communication unit 190.

Overall operations of the imaging apparatus 100 are controlled by the controller 170. The controller 170 may be configured to generate and send control signals to operating elements such as a lens driver 112, an aperture driver 115, and an image sensor controller 119.

The image capturing unit 110 generates electric image signals from light incident thereon, and includes a lens 111, the lens driver 112, an aperture 113, the aperture driver 115, an image sensor 118, and the image sensor controller 119.

The lens 111 may include, for example, a plurality of groups of lenses or a plurality of lenses. A position of the lens 111 may be controlled by the lens driver 112 based on the control signals output by the controller 170.

In addition, the lens driver 112 may adjust a focal distance by controlling the position of the lens 111, and may perform operations such as auto-focusing, zooming, and focus adjustment. When the lens driver 112 performs auto-focusing, an auxiliary light may be used to focus exactly on a subject.

The aperture 113, whose degree of opening is controlled by the aperture driver 115, may adjust an amount of light incident onto the image sensor 118.

Optical signals that passed through the lens 111 and the aperture 113 form an image of the subject on a light-receiving surface of the image sensor 118. The image sensor 118 may, for example, be a charge-coupled device (CCD) or a complementary metal-oxide semiconductor (CIS) image sensor, or the like, that converts optical signals into electric signals, according to an example. A sensitivity of the image sensor 118 may be controlled by the image sensor controller 119. The image sensor controller 119 may control the image sensor 118 in real time based on control signals that are automatically generated in response to input image signals or control signals that are manually input.

According to an example, the analog signal controller 121 performs noise reduction processing, gain adjustment, waveform shaping, analog-to-digital conversion, or the like on analog signals that are supplied by the image sensor 118.

According to an example, the image signal processor 120 performs certain process on image data signals that are processed by the analog signal controller 121. For example, the image signal processor 120 may reduce noise of input image data, and may, for example, perform image signal processes that improve image quality and generate special effects, such as gamma correction, color filter array interpolation, color matrix, color correction, color enhancement, white balance adjustment, brightness smoothing, and color shading, or the like. The image signal processor 120 may compress the image data to generate an image file, from which the image data may also be restored. A compression format of the image data may be reversible or irreversible. An example of a compression format of still images includes a joint photographic experts group (JPEG) or a JPEG 2000. When capturing moving images, a moving image file may be generated by compressing a plurality of frames according to a moving picture experts group (MPEG) standard. The image file may be generated according to an exchangeable image file format (Exif).

According to an example, the image signal processor 120 may generate a moving image from imaging signals that are generated by the image sensor 118. The image sensor 118 may generate frames to be included in the moving image file from the image signals, may code the frames according to a standard such as MPEG4, H.264/AVC, windows media video (WMV), etc., and may compress the frames so as to generate the moving image file. The moving image file may be generated in various formats such as mpg, mp4, 3gpp, avi, asf, mov, etc.

According to an example, the image data that is output from the image signal processor 120 is input to the store/read controller 140 directly, or via the memory 130. The store/read controller 140 may store the image data in the memory card 142 automatically, or based on a signal input by the user. The store/read controller 140 may read the image data from the image file stored in the memory card 142, and may send the image data to the display driver 162 via the memory 130 or by another path, so as to display the image on the display 164. The memory card 142 may be a separable component or a built-in component of the imaging apparatus 100. For example, the memory card 142 may be a flash memory card such as a secure digital (SD) card.

According to an example, the image signal processor 120 may also perform obscuring, coloring, blurring, edge enhancement, image analysis processing, image detecting processing, image effect processing, and the like. The image detection processing may be a face detection process, a scene detection process, or the like. Furthermore, the image signal processor 120 may process image signals to be displayed on the display 164. For example, brightness level adjustment, color correction, contrast adjustment, contour enhancement, screen division, character image generation, and image combination may be performed.

According to an example, the signals processed by the image signal processor 120 may be input to the controller 170 directly, or via the memory 130. The memory 130 may function as a main memory of the imaging apparatus 100, and may temporarily store information required during operations of the image signal processor 120 or the controller 170. The non-transitory program storage unit, e.g., program storage 150 stores programs that control the operation of the imaging apparatus 100, such as an operation system and an application system.

According to an example, the imaging apparatus 100 may include a display 164 that displays an operation status or information regarding an image captured by the imaging apparatus 100. The display 164 may display visual information and/or auditory information to the user. In order to display the visual information, the display 164 may include, for example, an LCD panel or an organic light-emitting display panel, or the like. Also, the display 164 may, for example, be a touch screen.

According to an example, the display driver 162 may send driving signals to the display 164.

According to an example, the viewfinder 160 may include a user gaze image capturing unit 165 and a viewfinder image display 167. The viewfinder 160 may correspond, for example, to the imaging apparatus 100d of FIG. 1D.

The user gaze image capturing unit 165 may capture an image including the pupil of the user. The user gaze image capturing unit 165 may obtain, for example, an image including a reference pupil showing an entire shape of the pupil of the user, and an image including a partial pupil showing a portion of the pupil. The image including the reference pupil and the image including the partial pupil captured by the user gaze image capturing unit 165 may be stored in the memory 130. When the viewfinder 160 corresponds to the imaging apparatus 100d of FIG. 1D, the user gaze image capturing unit 165 may correspond to the image capturing unit 10.

The viewfinder image display 167 may display viewfinder images or VR images. Also, the viewfinder image display 167 may display an object corresponding to the gaze. When the viewfinder 160 corresponds to the imaging apparatus 100d of FIG. 1D, the viewfinder image display 167 may correspond to the display 20.

According to an example, the viewfinder 160 may include, for example, an electronic viewfinder device or an optical viewfinder device. The viewfinder 160 may be included in the imaging apparatus 100 or a separable component of the imaging apparatus 100.

According to an example, the controller 170 may be configured to process image signals, and to control each element based on image signals or external input signals. The controller 170 may, for example, be a single processor or a plurality of processors. The controller 170 may, for example, be formed as an array of a plurality of logic gates or as a combination of universal microprocessor and a memory that stores a program that may be executed by the universal microprocessor. One of ordinary skill in the art will understand that the controller 170 may be formed by using various types of hardware or firmware.

According to an example, the controller 170 may be configured to execute programs stored in the non-transitory program storage unit 150. Alternatively, the controller 170 may include, for example, a separate module that generates control signals that control auto-focusing, zoom ratio changing, focus shifting, auto exposure correction, or the like, and may send the control signals to the aperture driver 115, the lens driver 112, and the image sensor controller 119. Thus, the controller 170 may be configured to control components of the imaging apparatus 100, such as a shutter and a strobe.

According to an example, the controller 170 may be connected to an external monitor (not shown), may be configured to perform a predetermined process on the image signals to be displayed on the external monitor, and to transmit the processed image signals so as to display the processed image signals on the external monitor.

According to an example embodiment, the controller 170 may be configured to determine a difference value between a first center that is determined based on an entire shape of the reference pupil and a second center that is determined based on a partial shape of the reference pupil. For example, the controller 170 may be configured to determine the center of an oval determined based on the entire shape of the reference pupil as the first center, and determine the center of an oval determined based on the partial shape of the reference pupil as the second center. In addition, the controller 170 may be configured to determine the center of an oval determined based on a predefined area of the partial pupil as the center of the partial pupil.

Also, the controller 170 may be configured to determine an error correction value for adjusting the center of the partial pupil based on the determined difference value between the first and second centers. The controller 170 may be configured to determine the center of the partial pupil using the determined error correction value.

According to an example, a user may input control signals via the operation unit 180. The operation unit 180 may, for example, include various functional buttons, such as a shutter-release button that generates shutter-release signals to control exposure of the image sensor 118 to light for a preset time period to capture an image, a power button that generates control signals to control a power on or power off operation, a zoom button that generates signals that control widening or narrowing an angle of view based on an input, a mode selection button, and other buttons that generate signals to control adjusting capture setting values. The operation unit 180 may, for example, be implemented in any form that allows the user to input the control signals, such as buttons, a keyboard, a touch pad, a touch screen, a remote control. etc.

According to an example, the communication unit 190 may include a network interface card (NIC) or a modem, and allow the electronic apparatus 100 to communicate with an external device in a network via wired or wireless connection.

The block diagram of the example imaging apparatus 100 shown in FIG. 4 is an example embodiment. The components in the block diagram may be combined, omitted, or a new component may be added based on the specification of the imaging apparatus 100. For example, if necessary, at least one component may be combined or a single may be divided into at least two components. Also, functions are performed by each of the blocks are performed by describing example embodiments. Specific functions or apparatuses do not limit the scope of the disclosure.

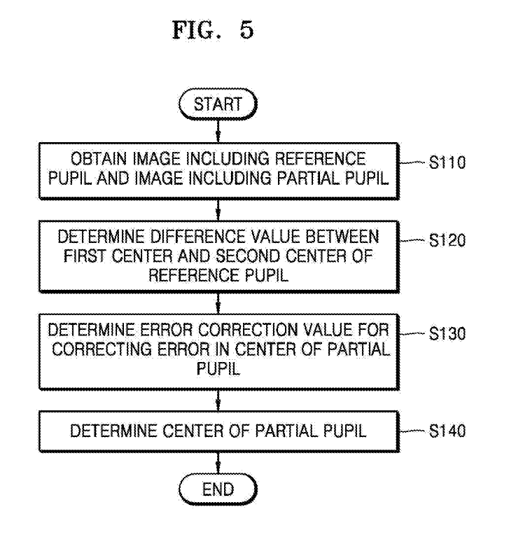

FIG. 5 is a flowchart illustrating an example operation method of the imaging apparatus 100.

In operation S110, the imaging apparatus 100 may obtain an image including a reference pupil of a user and an image including a partial pupil of the user (S110).

The imaging apparatus 100 may capture an image including the pupil of the user to track a user's eye gaze. Hereinafter, the image including the pupil of the user is obtained as a location of the face of the user and a location of the imaging apparatus 100 are fixed.

For example, when the pupil of the user is completely shown as in FIG. 2A, the imaging apparatus 100 may obtain the image including the reference pupil. When only a portion of the pupil is shown as in FIG. 2B, the imaging apparatus 100 may obtain the image including the partial pupil.

According to an example embodiment, when the entirety of the pupil appears during capturing of the image including the partial pupil, the imaging apparatus 100 may obtain the image including the reference pupil.

According to another example embodiment, the imaging apparatus 100 may obtain the image including the reference pupil before obtaining the image including the partial pupil.

The imaging apparatus 100 may provide a message that informs or notifies the user to open his/her eyes wide in order to obtain the image including the reference pupil. For example, the imaging apparatus 100 may display a message on a viewfinder image or a VR image to obtain the image including the reference pupil.

In operation S120, the imaging apparatus 100 may determine a difference value between a first center that is determined based on an entire shape of the reference pupil and a second center that is determined based on a partial shape of the reference pupil. (S120).

Referring to FIG. 6A, the imaging apparatus 100 may determine the center of an oval 615 obtained based on a shape of a reference pupil 611 as a first center 613.

The imaging apparatus 100 may determine the shape of the reference pupil 611 by obtaining an edge 610 between the reference pupil 611 and an iris 612. For example, the imaging apparatus 100 may measure brightness differences between adjacent pixels in an image including the reference pupil 611. The imaging apparatus 100 may obtain pixels that have a large brightness difference compared to adjacent pixels thereof. The imaging apparatus 100 may determine the obtained pixels as pixels that correspond to the edge 610 of a pupil. The imaging apparatus 100 may user canny edge detection to detect the edge.

Also, the imaging apparatus 100 may perform an operation of fitting the oval 615 to the pupil by using the pixels that correspond to the edge 610 of the pupil, and thus obtain the center of the oval 615. For example, the imaging apparatus 100 may use a Hough transform when fitting the oval 615 to the pupil. However, the fitting technique is not limited thereto. The imaging apparatus 100 may perform the fitting operation using other methods.

Referring to FIG. 6B, the imaging apparatus 100 may determine the center of an oval 620 obtained based on a partial shape 625 of a reference pupil 621 as a second center 623.

Referring to FIG. 6B, portions of the reference pupil 621 may have different radii of curvature. The imaging apparatus 100 may determine the center of the oval 620 differently based on which portion of the reference pupil 621 is used as a basis for performing the fitting operation using the oval 620.

According to an example embodiment, the imaging apparatus 100 may perform an operation of fitting the oval 620 to the pupil based on the partial shape 625 at least a lower area of the reference pupil 621. For example, the partial shape 625 may be an area indicated with a solid line in the reference pupil 621. The partial shape 625 may include, for example, half a circumference (610 of FIG. 6A) of the reference pupil 621.

According to another example embodiment, the imaging apparatus 100 may perform an operation of fitting a plurality of ovals to the pupil 621 based on partial shapes of the reference pupil 621 which are ⅓, ⅗, etc. the circumference of the reference pupil 621. The imaging apparatus 100 may determine the center of the plurality of ovals that fit based on the plurality of partial shapes as a second center.

Referring to FIGS. 6A and 6B, the first center 613 of the oval 615 obtained using the entire shape of the reference pupil 611 may be different from the second center 623 of the oval 620 obtained using the partial shape of the reference pupil 611.

Referring to FIG. 6C, the imaging apparatus 100 may determine a difference value 631 between the first center 613 determined based on the entire shape of the reference pupil 611 and the second center 623 obtained based on the partial shape of the reference pupil 611.

In operation S130, based on the determined difference value, the imaging apparatus 100 may determine an error correction value for correcting an error in the center of the partial pupil (S130).

Referring to FIG. 6C, the imaging apparatus 100 may determine the error correction value based on the difference value 631 between the first center 613 and the second center 623.

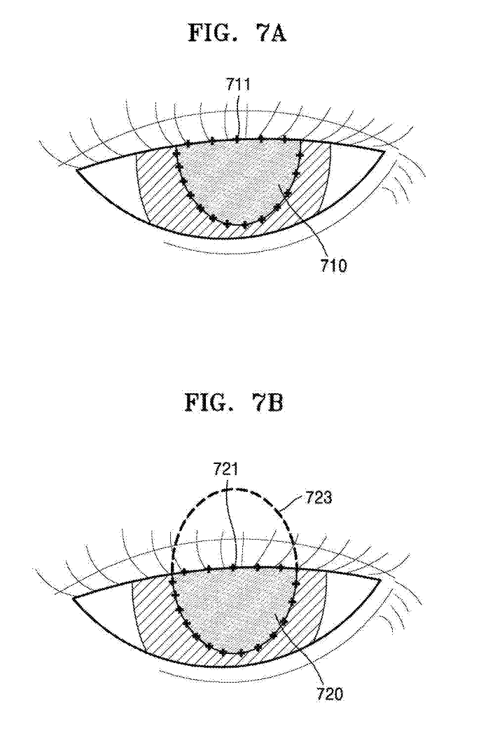

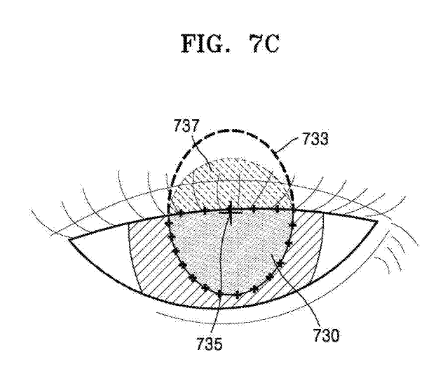

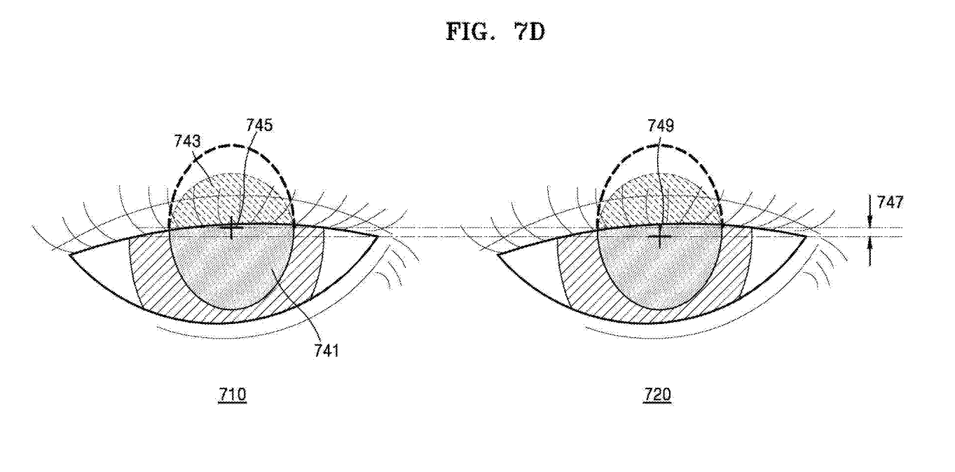

The error correction value may be used for correcting an error that is generated when the center of the pupil is obtained by using the partial pupil. As described above, since the portions of the pupil have different radii of curvature, there may be an error in the center (see, e.g., 735 of FIG. 7C) of the partial pupil when the imaging apparatus 100 obtains the center of the partial pupil. The imaging apparatus 100 may correct the error in the center of the partial pupil using the difference value 631 between the first center 613 and the second center 623.

In operation S140, the imaging apparatus 100 may determine the center of the partial pupil based on the determined error correction value (S140).

FIGS. 7A to 7D are diagrams illustrating an example imaging apparatus 100 determining the center of a partial pupil using an error correction value.

Referring to FIG. 7A, when only a portion of the pupil of the user is showing, the imaging apparatus 100 may obtain an image including a partial pupil 710.

The imaging apparatus 100 may first determine whether the partial pupil 710 includes a predefined area. When the partial pupil 710 includes the predefined area, the imaging apparatus 100 may determine the center of the partial pupil 710 using a determined error correction value.

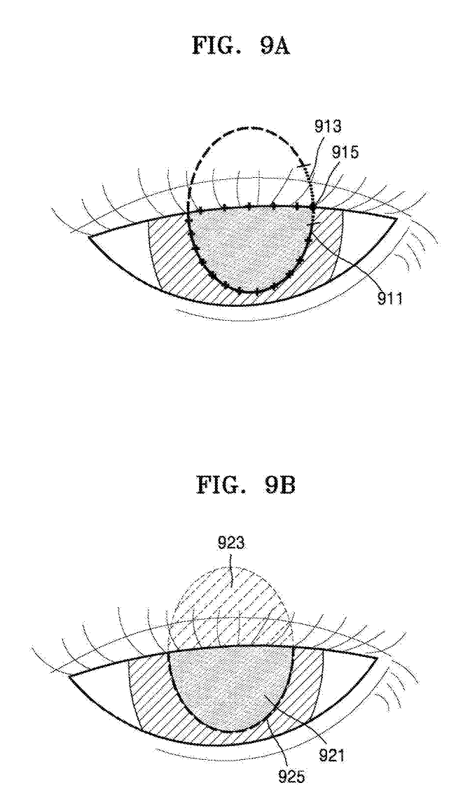

For example, a circumference of the predefined area may be half the circumference (see, e.g., 610 of FIG. 6A) of a reference pupil. In this case, the predefined area may be the partial shape 625 that is marked with a solid line in the reference pupil 621 illustrated in FIG. 6B. Alternatively, the predefined area may indicate half of the reference pupil. This will be described below with reference to FIGS. 9A and 9B.

Referring to FIG. 7A, the imaging apparatus 100 may obtain an edge of the partial pupil 710 by obtaining adjacent pixels that have large a brightness difference from the image including the partial pupil 710. When obtaining the edge of the partial pupil 710, the imaging apparatus 100 may utilize the method used to obtain the edge 610 of the reference pupil 611 described with reference to FIG. 6A.

According to an example embodiment, the imaging apparatus 100 may obtain distinguishing points 711 that indicate an edge of the pupil from the image including the partial pupil 710, and determine the edge of the partial pupil 710 using the distinguishing points 711. Also, the imaging apparatus 100 may use the distinguishing points 711 to determine whether the partial pupil 710 includes the predefined area. An example, in which the predefined area corresponds to the partial shape 625 of FIG. 6B and a circumference of the partial shape 625 is half (610 of FIG. 6A) of that of the reference pupil, will be described below.

Referring to FIG. 7B, the imaging apparatus 100 may obtain a plurality of distinguishing points 721 that indicate or define a partial pupil 720. The imaging apparatus 100 may obtain an oval 723 that corresponds to an edge of the partial pupil 720 using distinguishing points that indicate a predefined area.

Referring to FIG. 7C, the imaging apparatus 100 may determine the center 735 of an oval 733 that corresponds to an edge of a partial pupil 730.

As described above, the partial pupil 730 may not have a shape that is symmetrical to a portion 737 covered by an eyelid. When the imaging apparatus 100 determines a center 735 of the oval 733 that corresponds to the edge of the partial pupil 730 as the center of the pupil, the determined center of the pupil may be different from the center of the pupil that is obtained based on the entire shape of the reference pupil.

When capturing the pupil of the user, the imaging apparatus 100 usually captures only an image of a partial pupil because of the eyelid, and thus, it may be difficult for the imaging apparatus 100 to obtain the center of the pupil using the entire shape of the pupil. In this case, the imaging apparatus 100 may correct the center of the pupil based on the center 735 of the oval 733 and a pre-obtained error correction value.

Referring to FIG. 7D, the imaging apparatus 100 may correct a center 745 of an oval illustrated in 710 to be a corrected center 749 of the pupil illustrated in 720.

For example, the imaging apparatus 100 may determine the corrected center 749 of the pupil based on the center 745 of the oval that is obtained based on a shape of a partial pupil 741 and an error correction value 747 that is obtained in advance.

According to an example embodiment, the imaging apparatus 100 may determine the error correction value 747 based on a difference value between a first center that is determined based on an entire shape of a reference pupil and a second center that is determined based on a portion of the reference pupil.

According to an example embodiment, when a pre-obtained size of the reference pupil is the same as a size of a partial pupil, the imaging apparatus 100 may determine that an error correction value is the same as the difference value between the first and second centers. The size of the partial pupil may indicate a total size of the partial pupil 741 and a covered portion of the pupil in FIG. 7D. The imaging apparatus 100 may estimate the size of the partial pupil based on the size of the partial pupil 741.

According to another example embodiment, the size of the reference pupil may be different from the size of the partial pupil. In this case, the imaging apparatus 100 may determine an error correction value based on a difference value between a first center that is determined based on an entire shape of the reference pupil and a second center that is determined based on a portion of the reference pupil, the size of the reference pupil, and the size of the partial pupil.

When the size of the reference pupil and the size of the partial pupil are different, the imaging apparatus 100 may correct an error in the center of the partial pupil using a reference pupil that has the most similar size as the partial pupil from among pre-obtained reference pupils. When the imaging apparatus 100 obtains only one reference pupil, the imaging apparatus 100 may correct the error in the center of the partial pupil by applying, for example, an interpolation method to the difference value between the first and second centers that is determined by using the reference pupil.

As illustrated in FIG. 7D, the center 745 of the oval that is obtained based on the shape of the partial pupil 741 may be different from the corrected center 749 of the pupil by as much as the error correction value 747. Even when the error correction value 747 is relatively small, the error correction value 747 may greatly affect a gaze position when tracking the gaze. By tracking the gaze by using the corrected center 749 of the pupil, the imaging apparatus 100 may more accurately track the gaze even when the pupil is covered by the eyelid.

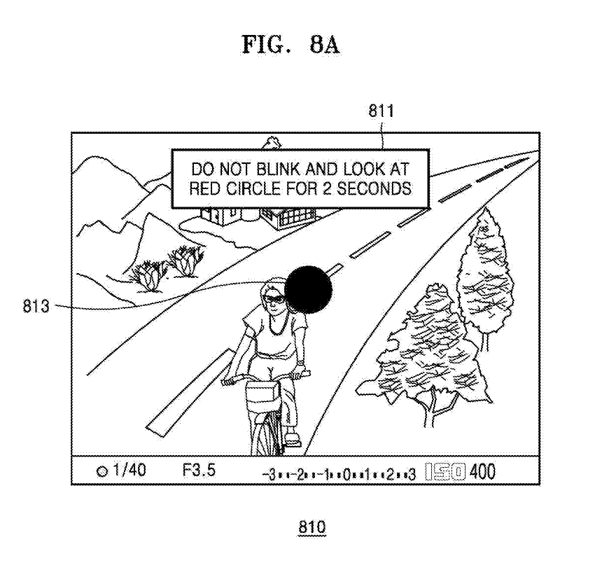

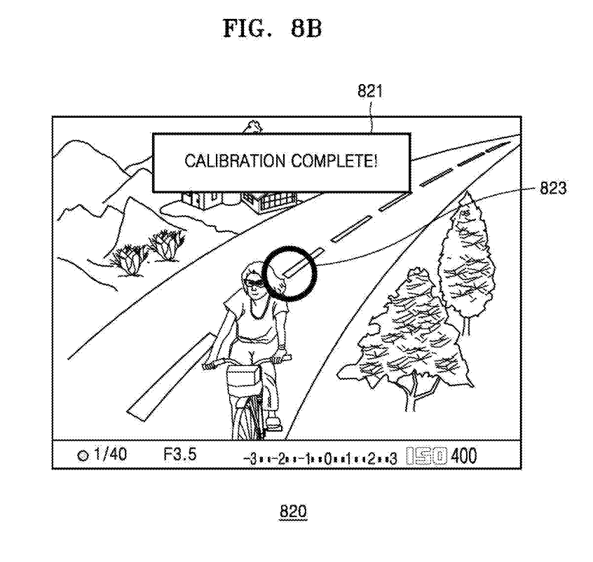

FIG. 8A illustrates an example image provided via a display when the imaging apparatus 100 obtains an image 810 including a reference pupil of a user.

Referring to FIG. 8A, the imaging apparatus 100 may provide a message 811 that notifies the user to open his/her eyes wide in order to obtain the image including the reference pupil. For example, the imaging apparatus 100 may display the message 811 on an image 810. The image 810 may include a viewfinder image or a VR image.

Also, referring to FIG. 8A, the imaging apparatus 100 may display, on the image 810, at least one object 813 that corresponds to a user's eye gaze which is tracked based on the center of a partial pupil of the user.

The imaging apparatus 100 may display the object 813 at a location in the image 810 which corresponds to the user's eye gaze. For example, when the user observes a person shown in the image 810, the imaging apparatus 100 may display the object 813 on the person in the image 810.

According to an example embodiment, before capturing an image including a pupil of the user, the imaging apparatus 100 may display a message for obtaining an image including a reference pupil on a display a. A user's eye gaze may not yet be tracked before the imaging apparatus 100 obtains the image including the pupil of the user. In this case, the imaging apparatus 100 may display the object 813 in an arbitrary location of the image 810. According to an example embodiment, the imaging apparatus 100 may display the object 813 as, for example, a red circle.

‘Calibration’ may refer, for example, to a process in which the imaging apparatus 100 captures the image including the reference pupil before starting to capture the image including the pupil of the user. When performing calibration, the imaging apparatus 100 may capture images of a plurality of reference pupils having a plurality of sizes and store the captured images of the reference pupils.

According to an example embodiment, the imaging apparatus 100 may change a size of the pupil of the user by providing light. For example, the imaging apparatus 100 may change the size of the pupil of the user by adjusting intensity of the light provided to the pupil of the user. According to an example embodiment, the imaging apparatus 100 may include at least one lighting unit to provide light when capturing an eye of the user. For example, the lighting unit may include infrared light-emitting diodes (LEDs).

When the imaging apparatus 100 obtains reference pupils of various sizes, even when a size of a partial pupil changes, the imaging apparatus 100 may estimate the center of the pupil more accurately based on the changed size. When the imaging apparatus 100 determines the center of the pupil based on a shape of the partial pupil, the imaging apparatus 100 may correct an error in the center of the partial pupil using a reference pupil that has the most similar size as the partial pupil from among the pre-obtained reference pupils. When the imaging apparatus 100 obtains only one reference pupil, the imaging apparatus 100 may correct the error in the center of the partial pupil by applying an interpolation method to a difference value between first and second centers that is determined using the reference pupil.

According to another example embodiment, the imaging apparatus 100 may display a message for obtaining the image including the reference pupil while obtaining an image including the partial pupil.

For example, after obtaining the image including the partial pupil, when a shape of the obtained partial pupil is different from a shape of a previously obtained partial pupil, the imaging apparatus 100 may obtain the image including the reference pupil again.

For example, the shape of the pupil of the user may change when brightness changes during capturing of images or when the user of the imaging apparatus 100 changes. The imaging apparatus 100 may determine whether the shape of the pupil of the user has changed by comparing a shape of a previously obtained reference pupil and a shape of a currently obtained partial pupil. When the shape of the pupil has changed, the imaging apparatus 100 may newly obtain the image including the reference pupil.

FIG. 8B is an image 820 provided via a display when the imaging apparatus 100 obtains an image including a reference pupil of the user, according to an example embodiment.

According to an example embodiment, after obtaining the image including the reference pupil of the user, the imaging apparatus 100 may provide a message informing the user that the image including the reference pupil is obtained. For example, the imaging apparatus 100 may display a message 821 informing the user that calibration is complete on an image 820. The imaging apparatus 100 may obtain the center of the pupil using a shape of reference pupil, and track a gaze by using the obtained center of the pupil. The imaging apparatus 100 may display an object 823 at a location corresponding to the tracked gaze. According to an example embodiment, the imaging apparatus 100 may display the object 823 as a green circle.

According to an example embodiment, an object (e.g., 813 of FIG. 8A) displayed before calibration is complete may be different from an object (e.g., 823 of FIG. 8B) displayed after calibration is complete.

FIGS. 9A and 9B are diagrams illustrating an example imaging apparatus 100 determining whether a partial pupil includes a predefined area.

According to an example embodiment, the predefined area of the partial pupil may correspond to a partial shape that is used to obtain a second center of the reference pupil. For example, the imaging apparatus 100 may obtain the second center of the reference pupil using at least half of an edge of the reference pupil. In this case the predefined area of the partial pupil may correspond to a lower portion of the reference pupil that includes at least half of the edge of the reference pupil.

Referring to FIG. 9A, the imaging apparatus 100 may obtain a plurality of distinguishing points that indicate an edge of the partial pupil. The imaging apparatus 100 may obtain an oval that corresponds to the edge of the partial pupil using the distinguishing points. Also, the imaging apparatus 100 may determine that a portion 913 of the oval that does not include the distinguishing points is a portion covered by the eyelid.

Referring to FIG. 9B, according to an example embodiment, the imaging apparatus 100 may define a partial pupil 921 by determining an edge 925 including the distinguishing points in the oval.

According to an example embodiment, when the imaging apparatus 100 determines that the edge 925 of the partial pupil 921 includes at least half of the edge of the oval that corresponds to the partial pupil 921, the imaging apparatus 100 may determine that the partial pupil 921 includes the predefined area.

According to another example embodiment, in the oval, the imaging apparatus 100 may determine a size of the partial pupil 921 and a size of an area 923 covered by the eyelid. According to an example embodiment, when the imaging apparatus 100 determines that the size of the partial pupil 921 corresponds to at least half of the size of the entire oval, the imaging apparatus 100 may determine that the partial pupil 921 includes the predefined area.

According to an example embodiment, when the imaging apparatus 100 determines that the partial pupil 921 includes the predefined area, the imaging apparatus 100 may determine the center using a shape of the partial pupil 921. When the imaging apparatus 100 determines that the partial pupil 921 does not include the predefined area, the imaging apparatus 100 may inform the user via the display that the user's eye gaze is not accurately tracked.

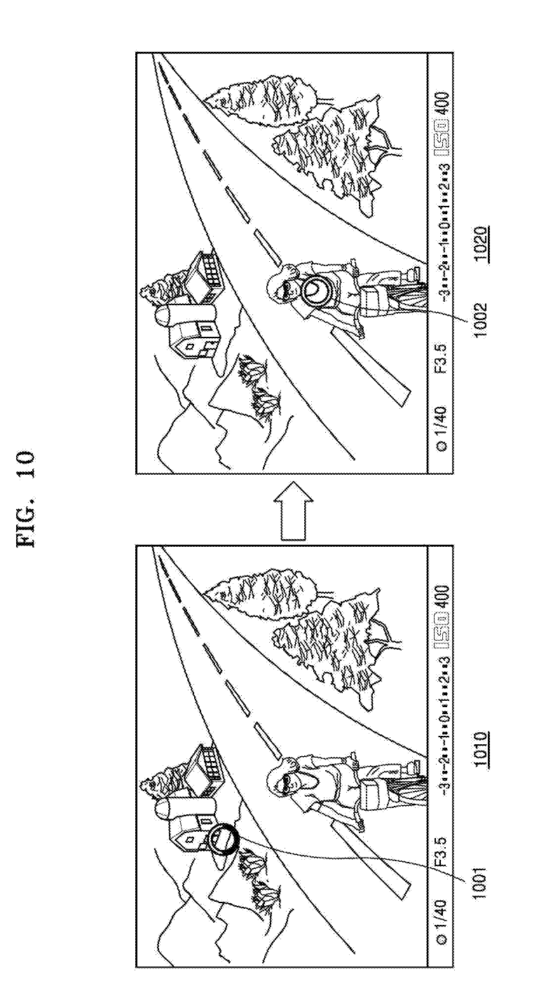

FIG. 10 is a diagram illustrating an example imaging apparatus 100 displaying, on a display of a display unit, whether a gaze of a user is tracked.

According to an example embodiment, the imaging apparatus 100 may capture an image of the pupil of the user, and determine whether a partial pupil includes a predefined area in a captured image including pupil.

In FIG. 10, 1010 may indicate, for example, an image displayed by the imaging apparatus 100 when the partial pupil of the user does not include the predefined area. 1020 may indicate, for example, an image displayed by the imaging apparatus 100 when the partial pupil of the user includes the predefined area.

Referring to 1010 of FIG. 10, when the partial pupil does not include the predefined area, the imaging apparatus 100 may display at least one object 1001 on the display in a first form to show that a user's eye gaze is not being accurately tracked.

The first form may notify the user that the user is not completely opening his/her eyes and guide the user to open his/her eyes wide. The imaging apparatus 100 may display the object 1001 as a circle. Referring to 1010 of FIG. 10, the imaging apparatus 100 may display a lower half of the object 1001 in red and an upper half of the object 1001 in gray on the display of the display unit.

Referring to 1020 of FIG. 10, when the partial pupil includes the predefined area, the imaging apparatus 100 may display at least one object 1002 on the display in a second form to show that the user's eye gaze is being tracked.

The second form may inform the user that the gaze is being tracked. The imaging apparatus 100 may display the object 1001 as a circle. Referring to 1020 of FIG. 10, the imaging apparatus 100 may display the object 1002 as a green circle on the display of the display unit.

The imaging apparatus 100 according to an example embodiment may display the object 1001 on the display when an obtained partial pupil does not include the predefined area because the user is not completely opening his/her eyes. When the user opens his/her eyes wide after noticing the object 1001 on the display of the display unit, the imaging apparatus 100 may determine that the obtained partial pupil includes the predefined area. In this case, the imaging apparatus 100 may change the image being displayed from 1010 of FIGS. 10 to 1020 of FIG. 20.

The imaging apparatus 100 may display an object that guides the user to open his/her eyes wide when the partial pupil does not include the predefined area. Therefore, the imaging apparatus 100 may accurately track the gaze by using the partial pupil of the user.

The imaging apparatus operation method according to example embodiments may be implemented through program instructions that are executable via various computer devices and recorded in computer-readable recording media. The computer-readable recording media may include program instructions, data files, data structures or a combination thereof. The program instructions may be specifically designed for the disclosure or may be well-known to one of ordinary skill in the art of computer software. Examples of the computer-readable recording media include magnetic media (e.g., hard disks, floppy disks, or magnetic tapes), optical media (e.g., CD-ROMs or DVDs), magneto-optical media (e.g., floptical disks), and hardware devices specifically designed to store and execute the program instructions (e.g., ROM or RAM). Examples of the program instructions not only include machine codes that are made by compilers but also computer-executable high level language codes that may be executed by using an interpreter.

It should be understood that example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. An imaging apparatus comprising:
image capturing circuitry configured to capture an image comprising an image of a reference pupil showing an entire shape of a pupil of an eye of a user and an image comprising an image of a partial pupil showing a portion of the pupil; and
a controller configured to determine a difference value between a first center that is determined based on the entire shape of the reference pupil and a second center that is determined based on a partial shape of the reference pupil, said controller being further configured to determine an error correction value for correcting an error related to a center of the partial pupil based on the difference value, and to determine the center of the partial pupil using the error correction value.

2. The imaging apparatus of claim 1, wherein the controller is configured to determine whether the partial pupil comprises a predefined area, and to determine the center of the partial pupil when the partial pupil comprises the predefined area.

3. The imaging apparatus of claim 1, wherein the controller is configured to determine the error correction value based on the difference value, a size of the reference pupil, and a size of the partial pupil.

4. The imaging apparatus of claim 1, wherein the controller is configured to track a user's eye gaze based on the determined center, and
the imaging apparatus further comprises a display displaying at least one object that corresponds to the tracked eye gaze.

5. The imaging apparatus of claim 4, wherein when the partial pupil does not comprise a predefined area, the controller is configured to display, on the display, the at least one object in a first form indicating that the user's eye gaze is not being tracked.

6. The imaging apparatus of claim 4, wherein when the partial pupil comprises the predefined area, the controller is configured to display, on the display, the at least one object in a second form indicating that the user's eye gaze is being tracked.

7. The imaging apparatus of claim 4, wherein the controller is configure to control the image capturing circuitry to display, on the display, a message for obtaining the image comprising the reference pupil.

8. The imaging apparatus of claim 1, wherein the image capturing circuitry is configured to capture images of a plurality of reference pupils having a plurality of sizes.

9. The imaging apparatus of claim 1, wherein the image capturing circuitry comprises an auxiliary light that provides light to the pupil of the user.

10. The imaging apparatus of claim 1, wherein the controller is configured to determine a center of an oval obtained based on the entire shape of the reference pupil as a first center,
to determine a center of an oval obtained based on the partial shape of the reference pupil as a second center, and
to determine a center of an oval obtained based on a shape of a predefined area of the partial pupil as a center of the partial pupil.

11. The imaging apparatus of claim 1, wherein the image capturing circuitry is configured to obtain the image comprising the partial pupil when a portion of the pupil of the eye of the user is covered by an eyelid.

12. The imaging apparatus of claim 1, wherein the controller is configured to obtain centers of a plurality of ovals based on the partial shape of the reference pupil, and to determine a plurality of second centers based on the centers of the plurality of ovals.

13. An imaging method comprising:
obtaining an image comprising at least one of: an image including a reference pupil showing an entire shape of a pupil of an eye of a user and an image including a partial pupil showing a portion of the pupil;
determining a difference value between a first center determined based on the entire shape of the reference pupil and a second center determined based on a partial shape of the reference pupil;
determining an error correction value for correcting an error related to a center of the partial pupil based on the difference value; and
determining the center of the partial pupil using the error correction value.

14. The method of claim 13, wherein the determining of the error correction value comprises:
determining whether the partial pupil comprises a predefined area; and
determining the error correction value when the partial pupil comprises the predefined area.

15. The method of claim 13, wherein the determining of the error correction value comprises determining the error correction value based on the difference value, a size of the reference pupil, and a size of the partial pupil.

16. The method of claim 13, further comprising tracking a user's eye gaze based on the determined center, and
displaying at least one object that corresponds to the tracked eye gaze on a display.

17. The method of claim 16, further comprising, when the partial pupil does not comprise a predefined area, displaying, on the display, the at least one object in a first form indicating that the user's eye gaze is not being tracked.

18. The method of claim 16, further comprising, when the partial pupil comprises the predefined area, displaying, on the display, the at least one object in a second form indicating that the user's eye gaze is being tracked.

19. The method of claim 13, further comprising, before obtaining the image comprising the partial pupil, displaying, on a display, a message for obtaining the image comprising the reference pupil.

20. The method of claim 13, wherein the determining of the error correction value comprises:
determining a center of an oval obtained based on the entire shape of the reference pupil as a first center;
determining a center of an oval obtained based on the partial shape of the reference pupil as a second center; and
determining a center of an oval obtained based on a shape of a predefined area of the partial pupil as a center of the partial pupil.
